(19) United States
(12) Patent Application Publication
(10) Pub. No.: US 2005/0064090 A1
(43) Pub. Date: Mar. 24, 2005

(54) Method for coating on laser-diode facet

(75) Inventors: Ting-Pi Yeh, Taipei City (TW); Ho-Lin Chang, Ping-Cheng City (TW); Shiun-Yi Li, Tau-Yuan City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Union Optronics Corporation

(21) Appl. No.: 10/671,181

(22) Filed: Sep. 24, 2003

(51) Int. Cl. B05D 5/06

(52) U.S. Cl. 427/58; 427/162

(57) ABSTRACT

A method for coating the facet of a laser-diode comprises the following steps: inserting a space bar between adjacent laser-diode chips, wherein each laser-diode chip has a first electrode surface, a second electrode surface, a first resonance facet covering on a waveguide wire, a second resonance facet, and a resonance length, and the space bar has a first surface and a second surface, the first surface having a trench crisscrossed with the waveguide wire on both of its fringes to expose the partial waveguide wire of the laser-diode chip, the first surface of the space bar coupling to the first electrode surface of the laser-diode chip, and the second surface coupling to the second electrode surface of the laser-diode chip; and coating onto the first and second resonance facets of the laser-diode chip.

### BACKGROUND OF THE INVENTION

1. Field of the Invention

This invention generally relates to the field of coating on the resonance facet of a laser-diode. More particularly, the present invention relates to a method for coating the resonance facet by modifying the shape of a space bar or a laser-diode chip, so as to uniformly coat on the resonance facet of a laser-diode.

2. Description of the Prior Art

Coating a thin film on the resonance facet of a laser-diode, such as dielectric material or other material is to protect the facet, to avoid the decline caused during operating, and to change the reflection rate of the facet to increase the electric conductivity property. As shown in FIG. 1a, the conventional approaches for coating a laser-diode facet are arranging the laser-diode chips 10; coupling adjacent electrode surfaces 12 to merely expose the first resonance facet 14a and the second resonance facet 14b; and coating a thin film onto the first resonance facet 14a. The outer chips are protected by a space bar or a clamp to avoid that the electrode surface 12 be covered during coatings. When the coating on the first resonance facet 14a is completed, the coating on the second resonance facet 14b continues.

The width of the laser-diode chip is around several hundred microns, and the thickness of the laser-diode chip is around 100 microns. The laser-diode chips are so slight, that the friction between the arranged chips causes the chips ragged, and so that the resonance facets of the chips are easily sheltered from the prominent part of the adjacent chips, causing a non-uniform coating. The non-uniform coating has affected the characteristic of the laser-diode chips. Therefore, as shown in FIG. 1b, in the prior art, a space bar 16 is inserted to separate the coupled laser-diode chips 10, wherein the width of the space bar 16 is smaller than the resonance length of the laser-diode chip. The first resonance facet 14a thus will not be sheltered from the prominent part of the adjacent chips. However, the second resonance facet 14b and the space bar 16 are still ragged because they aligned on another surface, and thus the second resonance facet 14b and the space bar 16 have to be rearranged again.

U.S. Pat. No. 6,125,530 relates an apparatus for rolling the facets of arranged chips, but the apparatus easily damages and contaminates the resonance facet of laser-diode chips after rolling. U.S. Pat. No. 5,911,830 and U.S. Pat. No. 6,026,557 both disclose a fixture for holding the laser-diode chips during coating, and placing a space bar to separate the coupled laser-diode chips, wherein the width of the space bar is smaller than the resonance length of the laser-diode chip. The above-mentioned patents all have to employ a precise and complicated clamping apparatus, which are large in size to occupy the space occupation, so that the yield of resonance facet coating will be reduced.

### SUMMARY OF THE INVENTION

The conventional coating method has caused many drawbacks in view of the prior art, and thus the present invention provides a method for coating laser-diode facet to overcome the drawbacks caused by the conventional technique.

The present invention is generally used for coating the laser-diode facet by modifying the shape of a space bar or a laser-diode chip, so as to uniformly coat on the resonance facet of a laser-diode. The present invention does not need to employ a complicated and huge clamping apparatus, so the production costs can be reduced. In addition, the present invention further provides a method for fabricating a laser-diode chip and a space bar which have the trenches.

To achieve the above objects, the present invention provides a method for coating the laser-diode facet, comprising the steps of inserting a space bar between adjacent laser-diode chips, wherein each laser-diode chip has a first electrode surface covering on a waveguide, a second electrode surface, a first resonance facet, a second resonance facet, and a resonance length, and the space bar has a first surface and a second surface, the first surface having a trench crisscrossed with the waveguide wire on its both fringes to expose the partial waveguide wire of the laser-diode chip, the first surface of the space bar coupling to the first electrode surface of the laser-diode chip, and the second surface coupling to the second electrode surface of the laser-diode chip; and coating onto the first and second resonance facets of the laser-diode chip.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIGS. 1a and 1b illustrate a conventional method for coating the resonance facets of laser-diode chips;

FIG. 2 illustrates a first preferred embodiment of the present invention;

FIGS. 3a to 3c illustrate the fabrication of the space bar shown in FIG. 2;

FIG. 4 illustrates a second preferred embodiment of the present invention;

FIGS. 5a to 5e illustrate the fabrication of the space bar shown in FIG. 4;

FIGS. 6a to 6c illustrate a third preferred embodiment of the present invention;

FIGS. 7a to 7c illustrate the fabrication of a laser-diode chip having trenches; and

FIG. 8 illustrates a fourth preferred embodiment of the present invention.

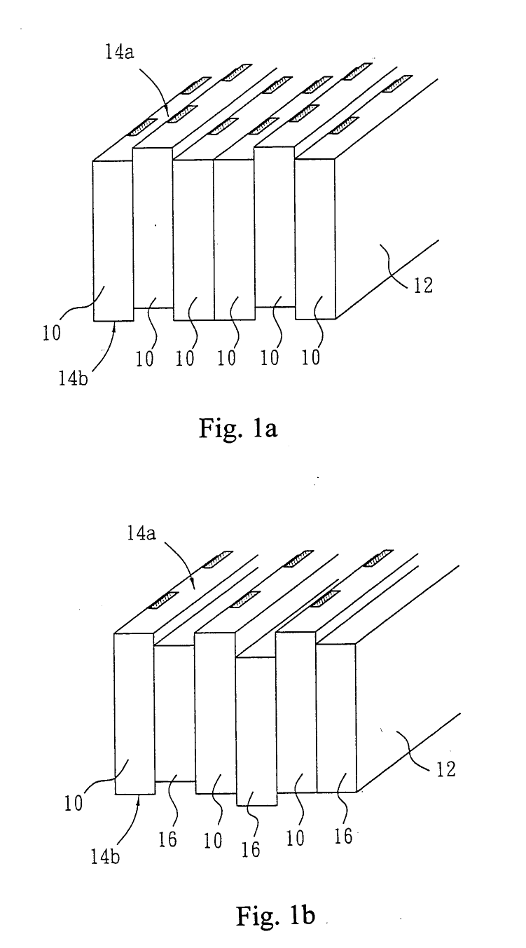

### DESCRIPTION OF THE PREFERRED EMBODIMENT

A number of embodiments of the invention will now be described in greater detail. Nevertheless, it should be noted that the present invention can be practiced in a wide range of other embodiments besides those explicitly described, and the scope of the present invention is not limited to that specified in the claims.

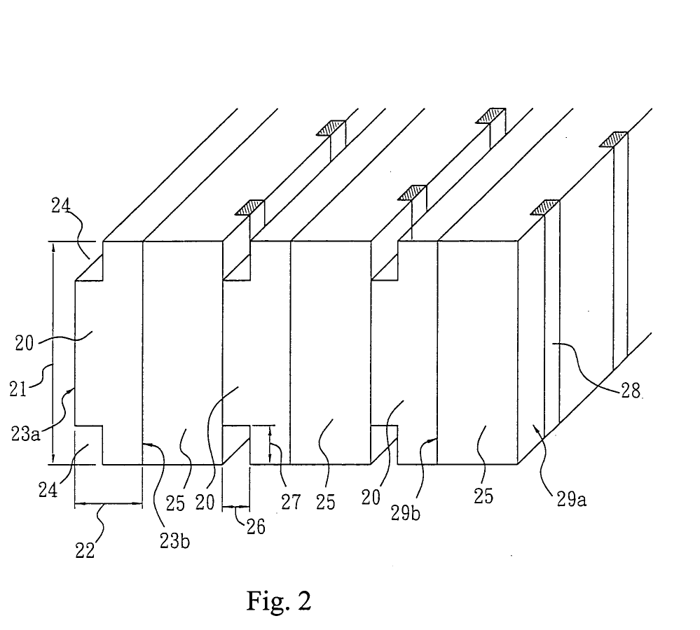

FIG. 2 illustrates the first embodiment of the present invention, in which the width 21 and the thickness 22 of the space bar 20 substantially equal to the resonance length and the thickness of the laser-diode chip 25, respectively, and the length of the space bar 20 is greater than that of the laser-diode chip 25. The space bar 20 has a first surface 23a and a second surface 23b, and each fringe of the first surface 23a has a trench 24, so that the two surfaces 23a and 23b of the space bar 20 have different widths. When arranging the laser-diode chips, a space bar 20 is inserted into adjacent laser-diode chips 25, so that the first surface 23a of the space bar 20 will face the first electrode 29a, which has a waveguide 28. Also, the second surface 23b of the space bar 20 faces the second electrode 29b of the laser-diode chips 25. Accordingly, the trench 24 is facing the waveguide 28, thereby exposing a partial resonance facet of the laser-diode chip.

The depth 26 and the width 27 of the trench 24 of the space bar are both greater than 5 microns, but the preferred depth is between 10-20 microns, and the preferred width is between 30-50 microns. The thickness of the space bar 20 is greater than 70 microns but is no more than 100 microns over the thickness of the laser-diode chip, and the preferred thickness is substantially equal to that of the laser-diode chip. The space bar 20 is selected from the materials consisting of semiconductor chip, metal, Teflon, plastic, etc.

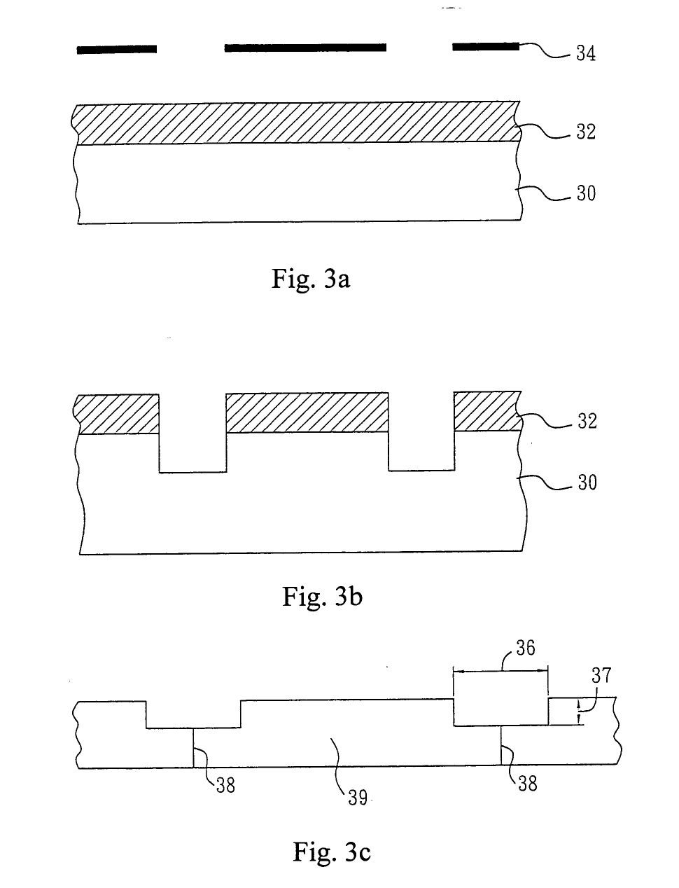

If the semiconductor chip is employed to be the material of the space bar, as shown in FIGS. 3a to 3c, the steps are forming a photoresist 32 on a semiconductor substrate 30; defining the trench locations by a patterned mask 34 and then proceeding an etching process to form the trenches; removing the mask 34 and the photoresist 32, wherein the width 36 and the depth 37 of the trench are greater than 10 and 5 microns; polishing the chip 30 until its thickness is approximately the same as that of the laser-diode chip; and cutting the chip 30 along the center line 38 of the trench to complete the fabrication of the space bar 39.

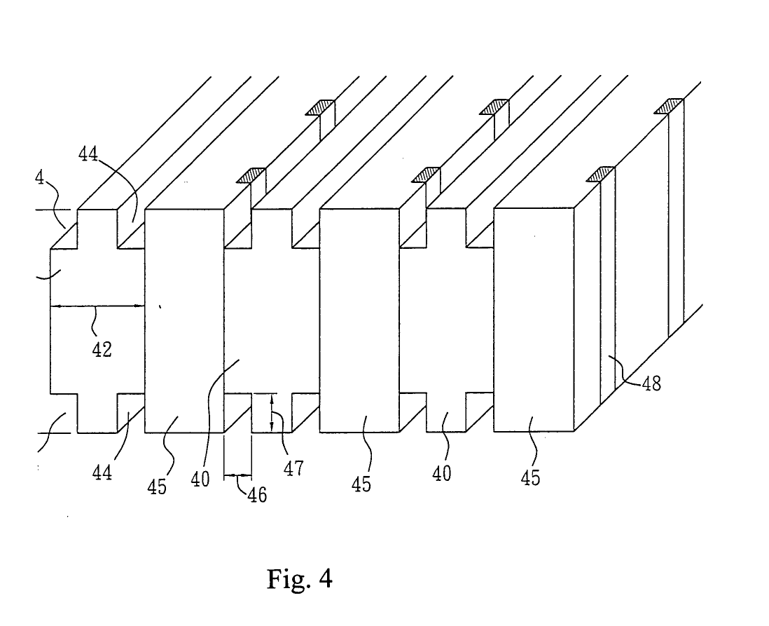

FIG. 4 illustrates the second embodiment of the present invention, in which the width 41 and the thickness 42 of the space bar 40 substantially equal to the resonance length and the thickness of the laser-diode chip, and the length of the space bar 40 is greater than that of the laser-diode chip. As shown in FIG. 4, each of the four corners of the space bar has a trench 44. The depth 46 and width 47 of the trenches 44 of the space bar are both greater than 5 microns, but the preferred depth 46 is between 10-20 microns, and the preferred width 47 is between 30-50 microns. The thickness of the space bar 40 is greater than 70 microns, but is no more than 100 microns over the thickness of the laser-diode chip, and the preferred thickness is substantially equal to that of the laser-diode chip. When the laser-diode chips are being arranged, a space bar 40 is inserted between the adjacent laser-diode chips 45, so that the trenches 44 of the space bar 40 will face the waveguide 48 of the laser-diode chip, and thus a partial resonance facet of the laser-diode chip can be disposed.

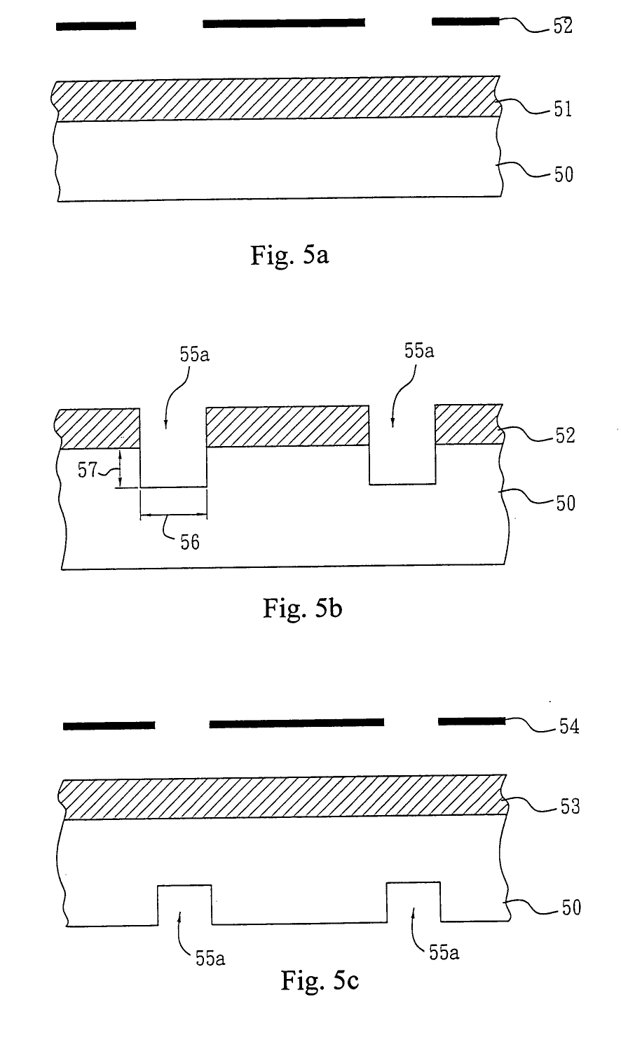

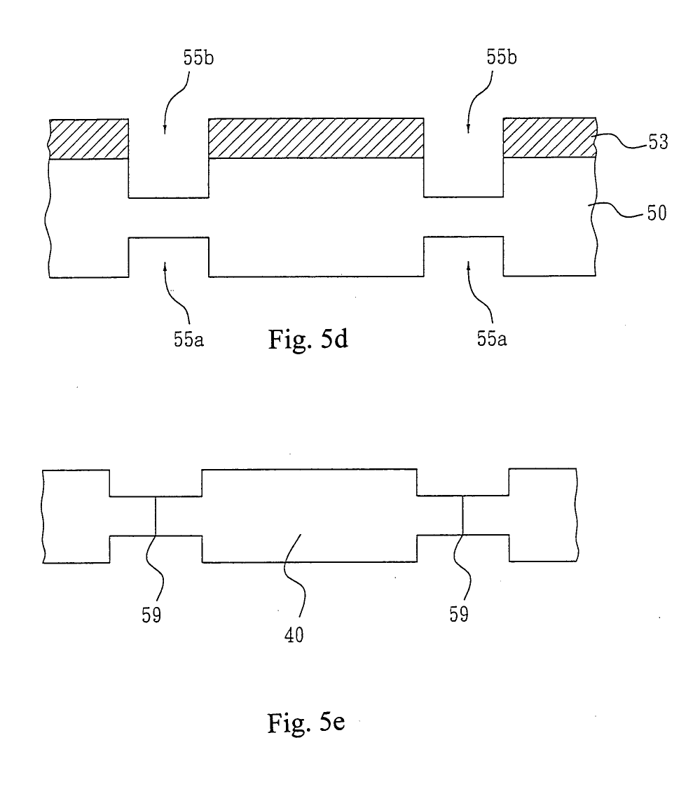

The material of fabricating the space bar 40 can be semiconductor chip, metal, Teflon, plastic, etc. If the semiconductor chip is employed to be the material of the space bar, as shown in FIGS. 5a to 5e, the steps are forming a first photoresist 51 on the first side of the semiconductor chip 50; defining the trench locations 55a by a first patterned mask 52 and then proceeding a etching process to form the first trench 55a, wherein the distance between the two trenches 55a is substantially equal to the width of the laser-diode chip, and the width 56 and depth 57 of the first trench is greater than 10 and 5 microns; removing the first mask 52 and the first photoresist 51 after the etching of the first trench 55a is completed, and then polishing the chip 50 until its thickness is approximately the same as that of the laser-diode chip; forming a second photoresist 53 on the second side of the semiconductor chip 50; defining the trench locations 55b in opposition to the trenches 55a by a second patterned mask 54, and then proceeding a etching process to form the second trench 55b; removing the second mask 54 and the second photoresist 53 after the etching of the second trench 55b is completed; and cutting the chip 50 along the center line 59 of the trench to complete the fabrication of the space bar 40.

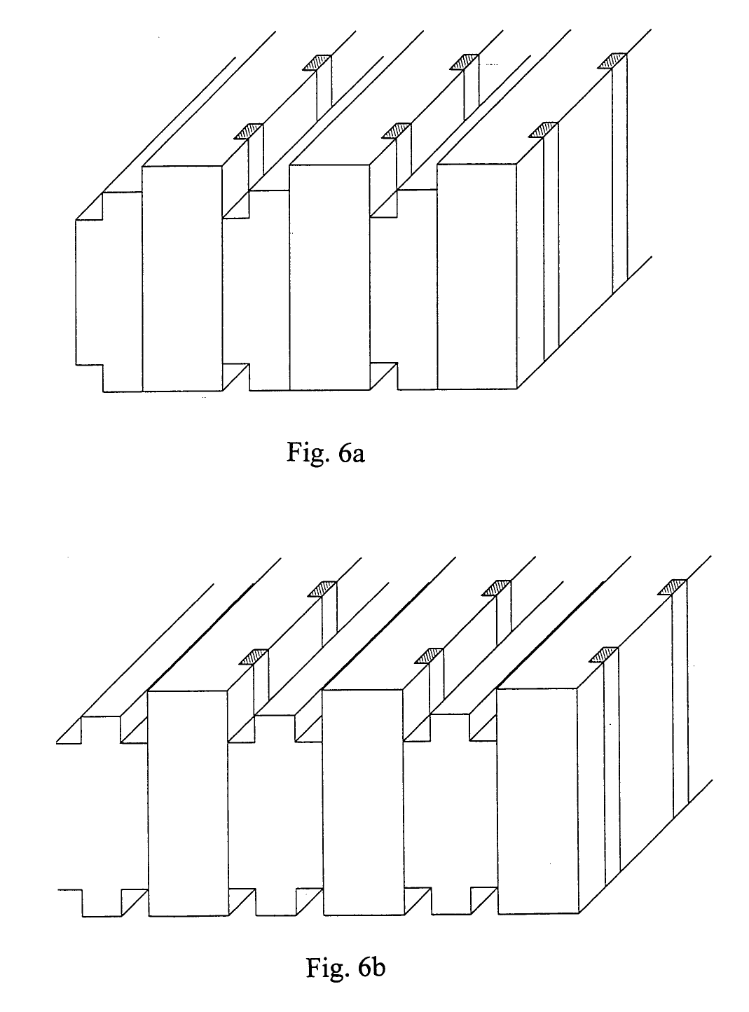

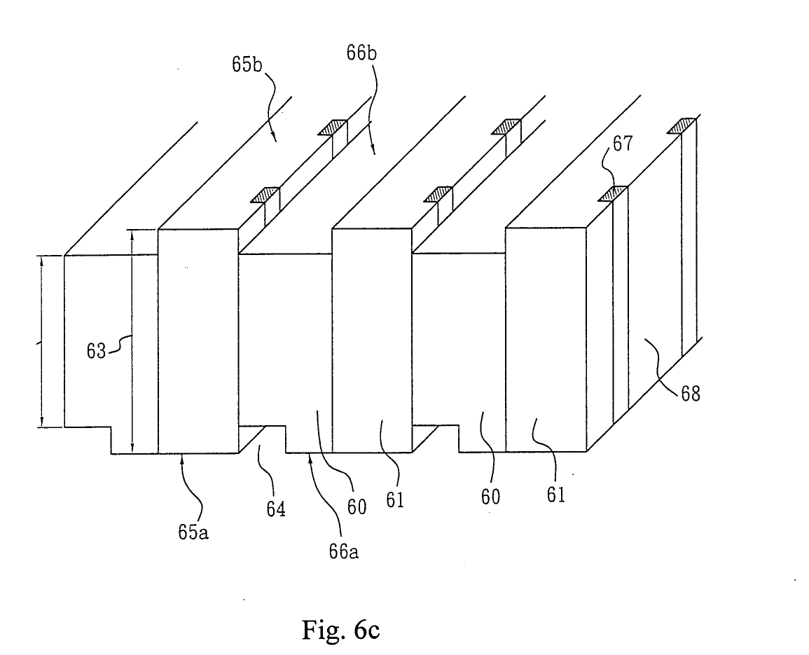

FIGS. 6a, 6b, and 6c illustrate a third preferred embodiment of the present invention. The space bars shown in FIGS. 6a and 6b have various shapes, in which the width may be shorter than the resonance length of the laser-diode chip, but the width of the space bar can be smaller than the resonance length of the laser-diode chip so as to avoid that the electrode surface are covered or sheltered during coating. As shown in FIG. 6c, the width 62 of the space bar 60 is shorter than the resonance length 63, and only the first surface 66a of the space bar 60 has a trench 64, but the second surface 66b does not. When the laser-diode chips are being arranged, a space bar 60 is inserted between the adjacent laser-diode chips 61, so that the trenches 64 of the space bar 60 will face the electrode surface 68 having a waveguide 67, and thus the resonance facets 65a and 65b of the laser-diode chip will not be sheltered.

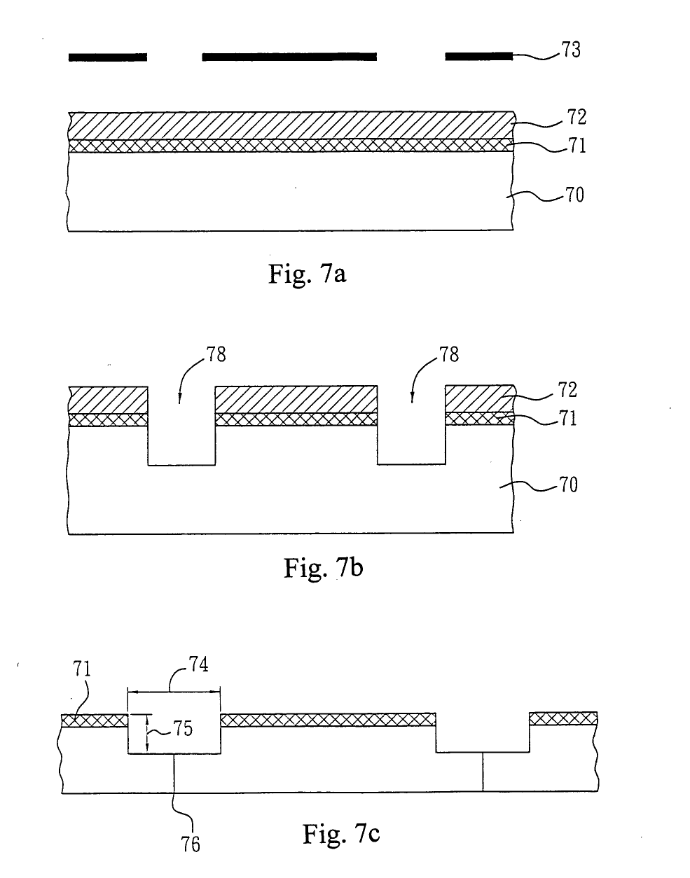

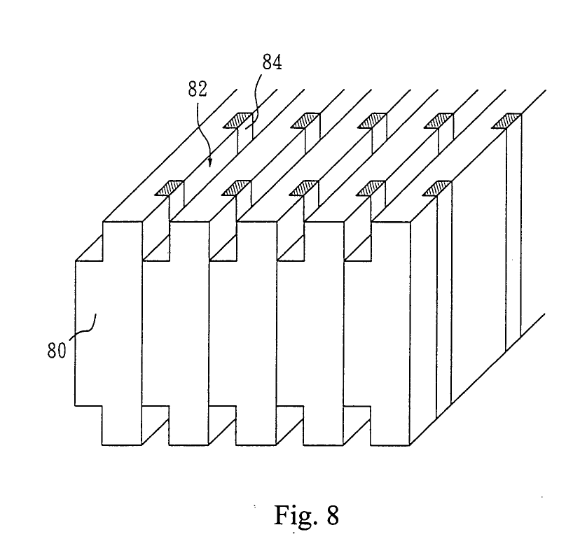

FIGS. 7a-7c illustrate the fabrication of a laser-diode chip having a trench structure. When the process of the first surface of the laser-diode chip 70 is completed, the second surface of the laser-diode chip 70 is polished and electroplated to form an electrode layer 71. A photoresist 72 is formed on the second surface of the laser-diode chip 70, a patterned mask 73 is used to define the location of a trench. The second surface is etched to form the trenches 78. The distance between two trenches substantially equals to the resonance length of the laser-diode chip, and the width 74 and the depth 75 of the trench 78 are greater than 10 and 5 microns. The photoresist 72 is removed after the etching process, and then the laser-diode chip is cut along the center line 76 of the trench to complete the fabrication of the laser-diode chip having a trench structure. FIG. 8 is a fourth preferred embodiment of the present invention. When the laser-diode chips are being arranged, a first electrode surface of a laser-diode chip couples to a second electrode surface of the adjacent laser-diode chip, so that the trench 82 of the laser-diode chip may face a waveguide 84 of the adjacent laser-diode chip, and thus the resonance facet of the laser-diode chip will not be sheltered.

According to the above description, the present invention is generally used for coating the laser-diode facet by modifying the shape of a space bar or a laser-diode chip, so as to uniformly coat on the resonance facet of a laser-diode. The present invention does not need to employ a complicated and huge clamping apparatus, so that the production costs can be reduced. In addition, the present invention further provides a method for fabricating a laser-diode chip and space bar which have the trenches.

Although specific embodiments have been illustrated and described, it will be obvious to those skilled in the art that various modifications may be made without departing from what is intended to be limited solely by the appended claims.

1. A method for coating on a laser-diode facet, comprising:
inserting a space bar between adjacent laser-diode chips, wherein each laser-diode chip has a first electrode surface covering on a waveguide of said laser-diode chip, a second electrode surface, a first resonance facet, a second resonance facet, and a resonance length, and said space bar has a first surface and a second surface, said first surface having a trench crisscrossed with said waveguide wire on both of its fringes, said first surface of said space bar coupling to said first electrode surface of said laser-diode chip, and said second surface coupling to said second electrode surface of said laser-diode chip;
coating on said first resonance facet; and
coating on said second resonance facet.

2. The method according to claim 1, wherein the width of said space bar is between said resonance length and 50 microns less than said resonance length.

3. The method according to claim 1, wherein when a space bar is inserted between adjacent laser-diode chips, said first surface and said second surface of the space bar do not exceed said first resonance facet and said second resonance facet of the laser-diode chip.

4. The method according to claim 1, wherein the thickness of said space bar is greater than 70 microns but no more than 100 microns over the thickness of said laser-diode chip.

5. The method according to claim 1, wherein the thickness of said space bar substantially equals to the thickness of said laser-diode chip.

6. The method according to claim 1, wherein said space bar is selected from the material consisting of semiconductor chip, metal, Teflon, and plastic.

7. The method according to claim 1, wherein said second surface further has a trench crisscrossed with said waveguide wire on both of its fringes.

8. The method according to claim 7, wherein the depth of said trench of said first surface is at least 5 microns, and the preferred depth is between 10-20 microns.

9. The method according to claim 7, wherein the width of said first surface is 10 microns shorter than said resonance length, and the preferred range of shortness is between 60 and 100 microns.

10. A method for coating on a laser-diode facet, comprising:
arranging a plurality of laser-diode chips, wherein each said laser-diode chip has a first electrode surface covering on a waveguide of said laser-diode chip, a second electrode surface, a first resonance facet, and a second resonance facet, wherein said second electrode surface has a trench crisscrossed with said waveguide wire on its both fringes, and said first electrode surface of said laser-diode chip couples to a second electrode surface of adjacent laser-diode chip;
coating on said first resonance facet; and
coating on said second resonance facet.

11. The method according to claim 10, wherein the depth and the width of said trench are greater than 5 microns.

12. The method according to claim 10, wherein the depth of said trench is between 10-20 microns.

13. The method according to claim 10, wherein the width of said second electrode surface is 60-100 microns shorter than a resonance length of said laser-diode chip.
